(19) United States
(12) Patent Application Publication
(10) Pub. No.: US 2026/0054223 A1
(43) Pub. Date: Feb. 26, 2026

(54) Reverse Osmosis Systems and Methods

(71) Applicants: Yale University, New Haven, CT (US); B.G. Negev Technologies and Applications Ltd., Beer-Sheva (IL); Colorado School of Mines, Golden, CO (US)

(72) Inventors: Jack Gilron, New Haven, CT (US); Menachem Elimelech, New Haven, CT (US); Tzahi Cath, New Haven, CT (US)

(21) Appl. No.: 19/375,977

(22) Filed: Oct. 31, 2025

Related U.S. Application Data
(63) Continuation-in-part of application No. 18/650,511, filed on Apr. 30, 2024.
(60) Provisional application No. 63/463,026, filed on Apr. 30, 2023.
(60) Provisional application No. 63/463,030, filed on Apr. 30, 2023.

(51) Int. Cl. B01D 61/58; B01D 61/02; B01D 61/04; B01D 61/42; B01D 61/46; C02F 1/44; C02F 1/469; C02F 103/06; C02F 103/08

(52) U.S. Cl. CPC B01D 61/58; B01D 61/04; C02F 1/441; C02F 1/4693; B01D 61/026; B01D 61/422; B01D 61/463; B01D 2311/04; B01D 2313/243; B01D 2313/246; B01D 2317/02; C02F 2103/06; C02F 2103/08; C02F 2301/046; C02F 2301/08; C02F 2303/22

(57) ABSTRACT

In some examples, the present invention relates a reverse osmosis system comprising: a feed source input; a high-pressure feed pump fluidly connected to the feed source input; a first energy recovery device fluidly connected to the high-pressure feed pump; a reverse osmosis (RO) cascade fluidly connected to the energy recovery device, wherein the RO cascade comprises: a seawater reverse osmosis (SWRO) stage comprising a SWRO membrane, fluidly connected to the first energy recovery device; and at least one low salt rejection reverse osmosis (LSRRO) stage comprising a LSRRO membrane, fluidly connected to the SWRO stage.

In some examples, the present invention relates to reverse osmosis methods comprising performing reverse osmosis on a fluid with the system described herein.

### CROSS-REFERENCE TO RELATED APPLICATIONS

This application is a Continuation-in-Part (CIP) claiming priority to U.S. application Ser. No. 18/650,511, filed on Apr. 30, 2024, which claims priority to U.S. provisional application No. 63/463,026 filed on Apr. 30, 2023, and to U.S. provisional application No. 63/463,030 filed on Apr. 30, 2023, each of which is incorporated herein by reference in its entirety.

### BACKGROUND OF THE INVENTION

Saline brines produced from desalination and industrial activity represent an environmental hazard if not properly disposed of. They can pollute the ground or fresh groundwater and surface water sources. Often the ideal solution from an environmental standpoint would be evaporation to dryness and internment so that the brines would not spread and contaminate land and water resources. In addition, there could be methods of obtaining valuable minerals by treating and purifying the concentrates. The classical methods of treating saline brines with thermal methods (multi-effect distillation and mechanical vapor compression evaporators) are highly energy intensive. If membrane processes could be used, this would represent a significant energy savings. One of the barriers to carrying out very high recovery reverse osmosis (RO) of brines (brackish groundwater, saline industrial effluents, seawater) is that the brines that would be generated from such operation would have osmotic pressures that exceed greater than 100 bar (1,450 psi) and would require the use of pressures and that are beyond the reach of conventional high salt rejection RO membranes and pumps that would be exceedingly expensive.

A number of approaches have been suggested using counter-current osmotic cascades and feeding the less saline streams on the permeate side to reduce the osmotic pressure difference (Osmotic assisted RO, or OARO). These approaches suffer from the internal concentration polarization that occurs in the membrane support. Another approach has been to apply electrodialysis (ED) to the treatment of RO concentrates produced for desalting brackish groundwater and combining the ED diluate with the RO permeate (Oren et al., Desalination, Vol. 261, 3, 321-330, 2010). This can result in recoveries of 97-98% with concentrate concentrations that approached 80-100 g/L. There are two problems with this approach. The first is when the concentrate concentration in ED gets too high, there is back diffusion and a drop in the electrical efficiency of the ED. The second problem is that the divalent scaling species (Ca, Ba, Mg, SO4) that are transferred from the diluate stream to the concentrate stream can cause scaling, that can only be partially treated by electrodialysis reversal (EDR) and sidestream concentrate crystallizer (Oren et al., Desalination, Vol. 261, 3, 321-330, 2010).

Thus, there is a need in the art for improved desalination methods. This invention satisfies this unmet need.

### SUMMARY OF THE INVENTION

In some examples, the present invention relates a reverse osmosis system comprising: a feed source input; a high-pressure feed pump fluidly connected to the feed source input; a first energy recovery device fluidly connected to the high-pressure feed pump; a reverse osmosis (RO) cascade fluidly connected to the energy recovery device, wherein the RO cascade comprises: a seawater reverse osmosis (SWRO) stage comprising a SWRO membrane, fluidly connected to the first energy recovery device; and at least one low salt rejection reverse osmosis (LSRRO) stage comprising a LSRRO membrane, fluidly connected to the SWRO stage. In some examples, the high-pressure feed pump is configured to: i) receive and increase the pressure of a feed from the feed source input; ii) receive and increase the pressure of a permeate output from the LSRRO stage; and iii) receive and increase the pressure of a concentrate output from the SWRO stage. In some examples, the first energy recovery device is configured to: i) receive and increase the pressure of a recycle stream from the high-pressure feed pump; and ii) recirculate the concentrate output from the SWRO stage to the high-pressure feed pump while recovering its mechanical energy. In some examples, the LSRRO stage further comprises a second high pressure feed pump fluidly connected to the SWRO stage; wherein the second high pressure feed pump is configured to: i) receive and increase the pressure of a portion of a concentrate output by the SWRO stage; ii) receive and increase the pressure of a portion of a permeate output by a second LSRRO or SWRO stage; and iii) receive and increase the pressure of a portion of the concentrate output from the LSRRO stage. In some examples, the LSRRO stage further comprises a second energy recovery device fluidly connected to the second high pressure feed pump; wherein the second energy recovery device is configured to: i) increase the pressure of a stream output from the second high pressure feed pump; and ii) recirculate the portion of concentrate output by the LSRRO stage to the second high pressure feed pump while recovering its mechanical energy. In some examples, the first and second energy recovery device is a pressure exchanger or pressure intensifier. In some examples, the LSRRO stage further comprises a booster pump configured to boost the pressure of at least a portion of a permeate output by the LSRRO stage to an inlet of a downstream LSRRO stage or to the SWRO stage.

In some examples, the system further comprises a monovalent selective electrodialysis (MSED) stage fluidly connected between the feed source and the RO cascade. In some examples, the MSED stage comprises an electrodialysis stack of alternating monovalent selective cation exchange membranes (CEM) and monovalent selective anion exchange membranes (AEM). In some examples, an input of the MSED stage includes an input configured to receive raw groundwater of low ion content water. In some examples, the system further comprises a scaling ion scavenging stage fluidly connected between the MSED stage and the RO cascade. In some examples, the RO cascade further comprises an antiscalant input fluidly connected to an inlet of the at least one LSRRO stage. In some examples, the antiscalant comprises a low molecular weight antiscalant.

In some examples, the LSRRO stage comprises a second LSRRO or SWRO stage downstream from the LSRRO stage. In some examples, the system further comprises at least a second feed source fluidly connected to an outlet of the SWRO stage and an inlet of the LSRRO stage and configured to: i) receive a concentrate output from the SWRO stage; ii) optionally receive a permeate output from second a LSRRO stage or SWRO stage; and iii) introduce a second feed to the LSRRO stage. In some examples, the feed source is configured to receive a permeate output from at least one LSRRO stage and a concentrate output from the SWRRO stage.

In some examples, the present invention relates to a reverse osmosis method, comprising: providing a reverse osmosis system described herein; inputting a high salinity fluid into the feed source; increasing the pressure of the high salinity fluid via the high-pressure feed pump to create an intermediate stream; increasing the pressure of the intermediate stream via the energy recovery device to create a pressurized stream; performing reverse osmosis on the pressurized stream via the SWRO stage to create a concentrate and a permeate; and collecting the permeate. In some examples, the method further comprises recirculating the concentrate via the energy recovery device to the high-pressure feed pump while recovering its mechanical energy. In some examples, the method further comprises introducing the concentrate to the LSRRO stage.

### BRIEF DESCRIPTION OF THE DRAWINGS

The following detailed description of embodiments of the invention will be better understood when read in conjunction with the appended drawings. It should be understood that the invention is not limited to the precise arrangements and instrumentalities of the embodiments shown in the drawings.

FIG. 1 depicts an exemplary scheme of low salt rejection reverse osmosis (LSRRO) membranes as envisaged and modeled.

FIG. 2, comprising FIG. 2A and FIG. 2B, depicts exemplary low salt rejection reverse osmosis schemes. FIG. 2A depicts an exemplary LSRRO process scheme using intermediate tanks and a batch series approach. FIG. 2B depicts an exemplary monoselective electrodialysis-LSRRO process scheme.

FIG. 3 depicts an illustration of an exemplary single stage system and method—recycling of concentrate across each stage.

FIG. 4 depicts an illustration of another exemplary system and method—recycling across each stage and using pressure exchanges to raise the pressure of permeate to feed pressure of previous stage.

FIG. 5 depicts a realization of exemplary low salt rejection reverse osmosis membranes cascades for very high salinity feeds with an external standard high salt rejection module.

FIG. 6 depicts an exemplary scheme for a low salt rejection reverse osmosis process with staged recycle for N stages with highest inlet pressure at the first stage. The incorporation of a high-pressure pump eliminates the need of concentrate booster pumps in some cases for feeding subsequent stages.

FIG. 7, comprising FIG. 7A and FIG. 7B, depicts exemplary process schemes of individual stages for realizing once-through LSRRO with staged recycle. FIG. 7A depicts and individual stage N showing requirement for recirculation booster pump and permeate booster pump to pressurize permeate to inlet pressure of stage N−1. FIG. 7B depicts a configuration of an individual stage with a pressure intensifier used to recover mechanical energy in recycled concentrate. A single booster pump raises the pressure of the feed to stage N, comprised of permeate from stage N+1 and concentrate from stage N−1. Subscripts in FIG. 7B represent as follows—f: total feed stream being fed to the LSRRO module; p: permeate produced by the LSRRO module; r: retentate leaving the LSRRO module; H: high pressure stream entering or leaving the ERD; L: low pressure stream entering or leaving the energy recovery device ((ERD): 206); b: brine stream leaving the recycle loop N (N−1) to be fed to stage N+1 (N); rec: recycle stream being fed back to inlet of booster pump 205. P is pressure, Q is flow, and C is concentration.

FIG. 8, comprising FIG. 8A and FIG. 8B, depicts exemplary three-stage LSRRO recycle cascades based on flexible reverse osmosis (FLERO)-type stages. FIG. 8A depicts an exemplary process and instrumentation schematic showing measurement points in the pilot, as well as stage inlet and outlet flows. The dashed lines on the final permeate and brine indicate the full recirculation operation mode adopted. FIG. 8B depicts a photo of a system comprising a pressure intensifier for each stage and the retentate streams Q_{r,1}-Q_{r,3} leaving each stage. Labels in FIG. 8A represent as follows-HLS: High level switch on tank; LLS: Low level switch on tank; Fi: flow indicator for stage i; TI: temperature indicator; PI: pressure indictor; ECi for stage i: conductivity indicator for stage i.

FIG. 9, comprising FIG. 9A through FIG. 9D, depicts charts with data showing feed volumes treated to achieve steady state of concentration factor and feed pressures. FIG. 9A depicts a chart with concentration factor CF (C_{b}/C_{f}) for volumes (V_{f}(L)) of feed solutions. FIG. 9B depicts a chart with data for feed pressure (P_{feed}(bar)) for volumes of feed solutions (C_{f}=26.9 g/L). FIG. 9C depicts a chart with data for feed pressure (P_{feed}(bar)) for volumes of feed solutions (C_{f}=29.2 g/L). FIG. 9D depicts a chart with data for feed pressure (P_{feed}(bar)) for volumes of feed solutions (C_{f}=33.3 g/L).

FIG. 10, comprising FIG. 10A and FIG. 10B, depicts charts with data for LSRRO performance. FIG. 10A depicts a chart with data for system water recovery Y_{LSRRO} (Qₚ/Q_{f}) for different feed concentrations C_{f} (g/L). FIG. 10B depicts a chart with data for concentration factor CF (C_{b}/C_{f}) for different feed concentrations C_{f} (g/L) and final brine concentration, C_{b} (g/L), achieved for all feed solutions tested.

FIG. 11 depicts a chart with element average inlet pressures P_{feed} (bar) or P_{f,i} for each stage as a function of the initial feed concentration C_{f}. Error bars denote to the feed pressure variation across each experimental run.

FIG. 12 depicts a chart with energy requirements of the LSRRO cascade. Power consumed by each stage is plotted on the left y-axis, and stage number is represented by the numbers on each bar and their color intensity. Values were calculated using equation (6) from Example 5. Specific energy consumption (SEC) estimated through equation (5) (from example 5) is overlayed, with values represented on the right y-axis.

### DETAILED DESCRIPTION

It is to be understood that the Figures and descriptions of the present invention have been simplified to illustrate elements that are relevant for a clear understanding of the present invention, while eliminating, for the purpose of clarity, many other elements used in reverse osmosis systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, or ±0.1% from the specified value, as such variations are appropriate to perform the disclosed methods.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### DESCRIPTION

The present invention relates to a purification system comprising a cascade of low salt-rejection reverse osmosis membranes.

### Purification System

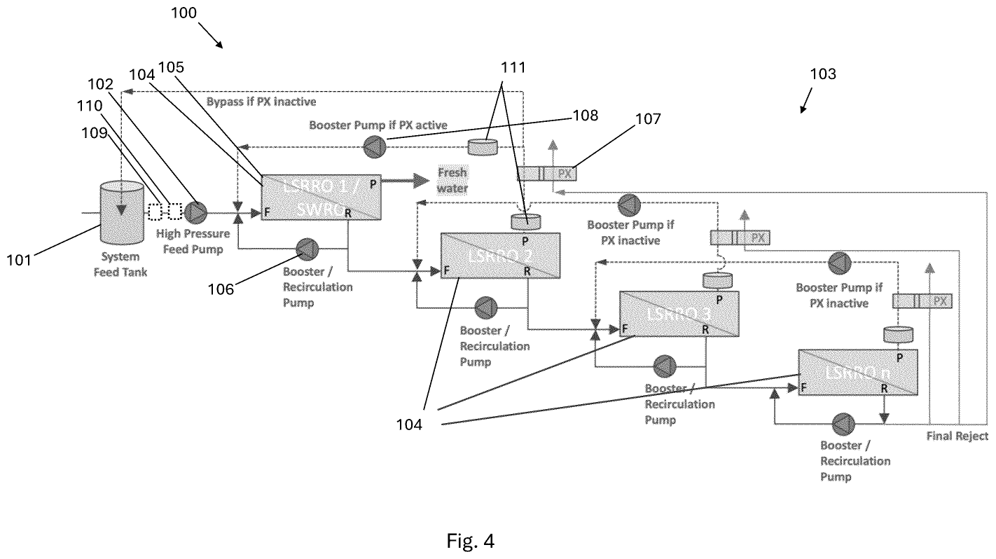

As shown in FIG. 4, the present invention relates in part to a purification system 100, comprising a cascade 103 of low salt-rejection reverse-osmosis membranes. In an aspect of the invention, the purification system 100 comprises one or more stages. In some embodiments, the purification system comprises a feed source input 101. In some embodiments, the reverse osmosis cascade 103 comprises one or more low salt rejection reverse osmosis (LSRRO) stages 104 including one or more LSRRO membranes. In some embodiments, the reverse osmosis cascade 103 comprises one or more seawater reverse osmosis (SWRO) stages 105 including one or more SWRO membranes, fluidly connected to the one or more LSRRO stages 104. In some embodiments, a high-pressure feed pump 102 is fluidly connected to the feed source input 101. In some embodiments, the feed source 101 comprises a feed tank. In some embodiments, the system 100 comprises a monoselective electrodialysis (MSED) stage 109 fluidly connected between the feed source 101 and the RO cascade 103. In one embodiment, the MSED stage 109 comprises an electrodialysis stack of alternating cation exchange membranes (CEM) and anion exchange membranes (AEM). In one embodiment, an input of the MSED stage 109 includes an inlet configured to receive raw groundwater of low ion content water. In one embodiment, the system 100 further comprises a scaling ion scavenging stage 110 fluidly connected between the MSED stage 109 and the RO cascade 103. In one embodiment, the SWRO stage 105 comprises the first stage of the RO cascade 103. In one embodiment, RO cascade 103 further comprises an antiscalant input fluidly connected to an inlet of the at least one LSRRO stage 104. In one embodiment, the antiscalant comprises a low molecular weight antiscalant. In one embodiment, the at least one LSRRO stage 104 comprises two or more LSRRO stages. In one embodiment, the two or more LSRRO stages 104 are connected in series. In one embodiment, the two or more LSRRO stages 104 are connected in parallel. In one embodiment, the system 100 further comprises at least one permeate storage tank 111 fluidly connected to at least a portion of one or more permeate outlets of the RO cascade 103. In one embodiment, the permeate storage tank 111 is fluidly connected to one or more inputs of RO cascade 103.

In one embodiment, each stage of the RO cascade 103 comprises an inlet, one or more outlets, and a semipermeable membrane. In one embodiment, the stages comprise a low salt-rejection reverse-osmosis membrane. In one embodiment, the low salt-rejection reverse-osmosis membrane comprises an inlet and one or more outlets. In one embodiment, the stages comprise a standard high salt rejection module. In one embodiment, the outlet of the feed source input is fluidly connected to the inlet of the first stage with a low salt-rejection reverse-osmosis membrane. In one embodiment, the outlet of a low salt-rejection reverse-osmosis membrane is fluidly connected to the inlet of another low salt-rejection reverse-osmosis membrane. In one embodiment, the outlet of a low salt-rejection reverse-osmosis membrane is fluidly connected to an intermediate container. In one embodiment, the outlet of a low salt-rejection reverse-osmosis membrane is fluidly connected to the feed source input. In one embodiment, the outlet of a low salt-rejection reverse-osmosis membrane is fluidly connected to a standard high salt rejection module. In one embodiment, the stages comprise pumps. In one embodiment, the stages comprise one more recirculation pumps 106. In one embodiment, the stages comprise one more pressure exchangers 107. In one embodiment the stages comprise one or more high pressure pumps. The pressure exchangers 107 comprise an inlet A and an outlet B. In one embodiment, contaminated fluid from the system feed tank 101 is pumped through the stages. In one embodiment, pumping the contaminated fluid through the stages desalinizes the fluid. In one embodiment, purified fluid is collected from any one of the stages. In one embodiment, brine is collected from any one of the stages. In one embodiment, concentrate is collected from any one of the stages.

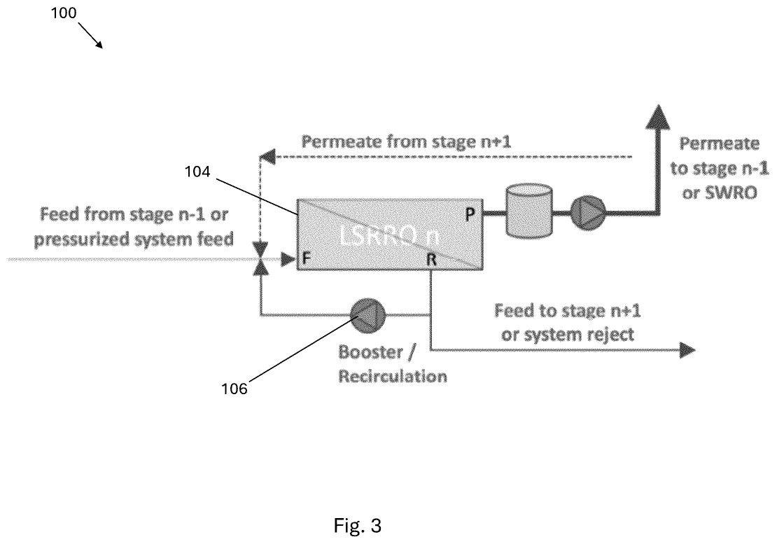

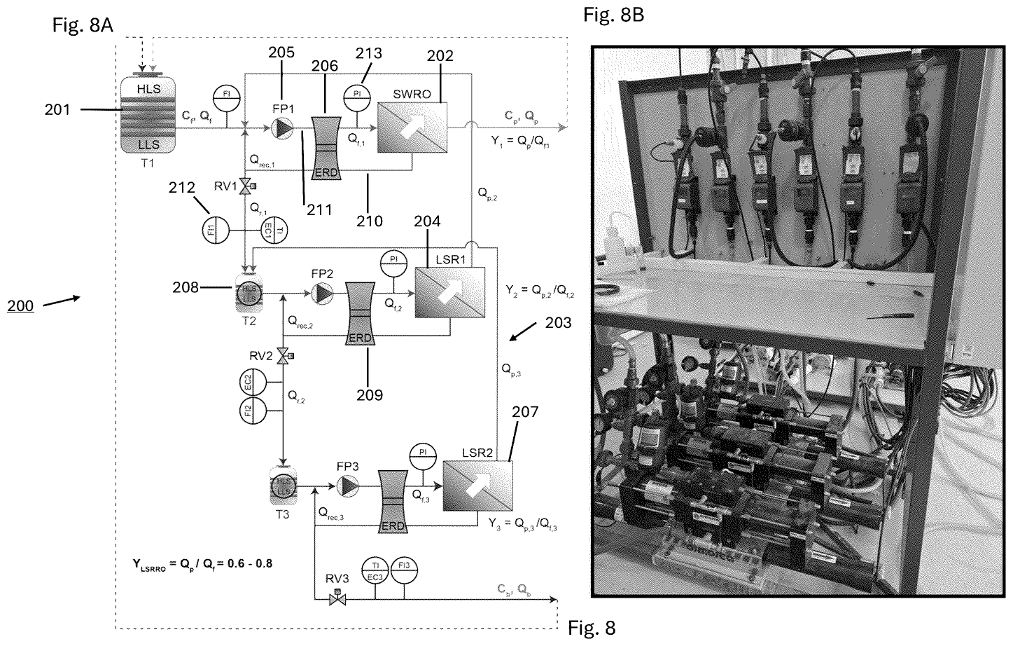

In some embodiments, the present invention relates in part to purification system 200, as shown in FIG. 8A. In some embodiments, purification system 200 may include any of the components, features, or configurations described herein with respect to purification system 100. This may include embodiments relating to, but not limited to, stages, membranes, feed sources, antiscalants, storage tanks, pumps, pressure exchangers, and the like. In some embodiments, the configurations and components from FIG. 3 and FIG. 4 thereby apply to purification system 200.

In some embodiments, purification system 200 comprises one or more stages described herein. In some embodiments, purification system 200 comprises a feed source input 201. In some embodiments, purification system 200 comprises one or more SWRO stages 202 comprising one or more seawater reverse osmosis membranes. In some embodiments, purification system 200 comprises one or more SWRO stages 202 fluidly connected to a reverse osmosis cascade 203. In some embodiments, reverse osmosis cascade 203 comprises one or more LSRRO stages 204 including one or more LSRRO membranes. In some embodiments, reverse osmosis cascade 203 comprises one or more LSRRO stages 204 comprising a semipermeable membrane described elsewhere herein. In some embodiments, reverse osmosis cascade 203 comprises one or more SWRO stages. In some embodiments, purification system 200 comprises one or more SWRO stages 202 fluidly connected to one or more LSRRO stages 204. In some embodiments, purification system 200 comprises a high-pressure feed pump or booster pump 205 fluidly connected to a feed source input 201. In some embodiments, purification system 200 comprises an energy recovery device 206 fluidly connected to the feed source input 201. In some embodiments, energy recovery device 206 is fluidly connected to the high-pressure feed pump 205, the SWRO stage 202, and the RO cascade 203, or any combination thereof.

As further shown in FIG. 8A, in some embodiments, the purification system 200 may comprise an energy recovery device 206 configured to recover energy from a high-pressure stream or concentrate 210 within the system and deliver at least a portion of the recovered energy to another stream 211 within the system and optionally within the same stage N. In some examples, purification system 200 comprises at least two energy recovery devices, as further shown in FIG. 8A. Any energy recovery device described herein may include, but is not limited to, a pressure exchanger, a pressure intensifier, a water turbine, an impulse-type water turbine, a Pelton wheel, an energy recovery turbine, and combinations thereof. The energy recovery device may be configured to improve the overall energy efficiency of the purification system by reducing the amount of external energy required to operate high-pressure pumps.

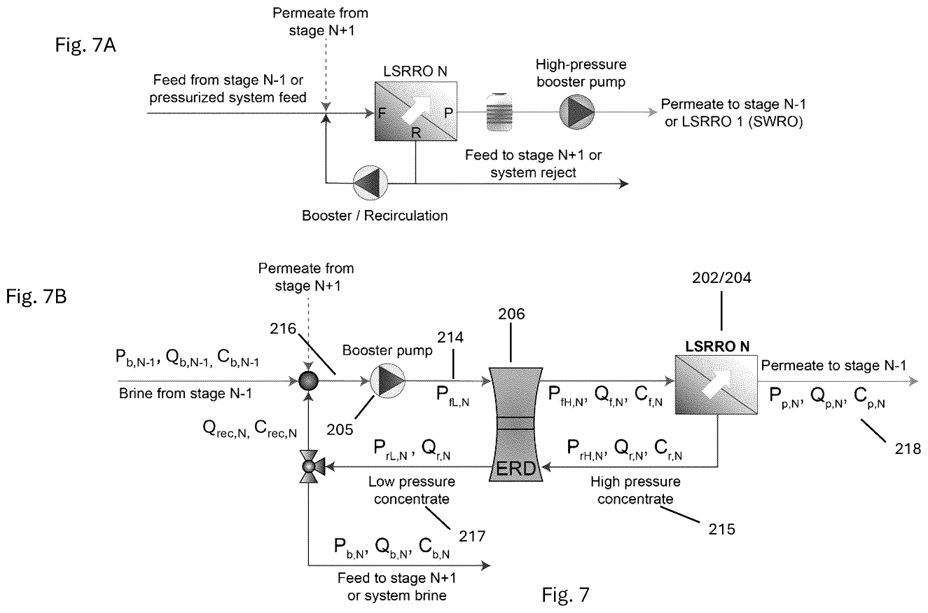

In a particular embodiment, and now referring to FIG. 7B, a stage N may comprise an energy recovery device 206 fluidly connected to a booster pump or high-pressure feed pump 205 and to an inlet of a SWRO or LSSRO stage 202/204 at stage N. In some embodiments, the energy recovery device 206 is configured to receive and increase the pressure of a feed/stream 214 from the high-pressure feed pump or booster pump 205 before introducing it to the inlet of the SWRO or LSSRO stage. In some embodiments, the energy recovery device is configured to recirculate a concentrate output 215 from the SWRO or LSSRO stage to the high-pressure feed pump 205, while recovering its mechanical energy. In some embodiments, the booster pump or high pressure feed pump 205 is configured receive and increase the pressure of a feed 216, which may include mixtures of fluids from any part of the system, which may include but is not limited to, feed from a feed source input anywhere in the system, brine or concentrate output from a stage N−1, a permeate output from a stage N+1, and a concentrate output 217 from stage N itself. In some embodiments, stage N is fluidly connected to stage N−1. In some embodiments, stage N is configured to introduce a permeate output to stage N−1, wherein the permeate output combines with a feed from a feed source input to stage N−1 and/or a concentrate output from stage N−2, prior to being introduced to the high-pressure feed pump or booster pump at N−1.

In some embodiments, the system 200 comprises a monovalent-selective electrodialysis (MSED) stage (109 in FIG. 4) fluidly connected between the feed source 201 and the SWRO stage 202. In some embodiments, the system 200 further comprises a scaling ion scavenging stage (110 in FIG. 4) fluidly connected between the MSED stage and the SWRO stage 202. In some embodiments, RO cascade 203 further comprises an antiscalant input fluidly connected to an inlet to any of the stages in purification system 200. In some embodiments, purification system 200 comprises two or more LSRRO or SWRO stages. In some embodiments, the two or more LSRRO stages or SWRO stages are connected in series. In some embodiments, the two or more LSRRO stages or SWRO stages are connected in parallel. In some embodiments, the system 200 further comprises at least a second feed source 208 (FIG. 8A) fluidly connected to at least one or more permeate outlets from one of the stages and at least one or more concentrate outlets from one or more of the stages. In some embodiments, the second feed source input 208 is fluidly connected to the SWRO stage 202 and at least one of the stages from the RO cascade. In some embodiments, feed source input 201 is fluidly connected to the SWRO stage 202 and at least one of the stages from the RO cascade. In some embodiments, purification system 200 comprises at least a second energy recovery device 209 fluidly connected to a stage in the RO cascade. In some embodiments, the second energy recovery device 209 is fluidly connected to a second feed source input 208 and an LSRRO stage 204.

In some embodiments, purification system 200 comprises indicators to monitor system parameters, including, but not limited to, pressure indicators, temperature indicators, flow indicators, pH indicators, and electrical conductivity indicators. In some embodiments, system 200 comprises heat exchangers and or/chillers. In some embodiments, system 200 comprises heat exchangers and or/chillers between a feed source input and a high-pressure feed pump. In some embodiments, purification system 200 comprises a flow indicator 212 between stages. In some embodiments, purification system 200 comprises pressure indicators 213 between energy recovery devices and stages.

In some embodiments, a feed source input flows into the inlet of a stage N and a permeate flows out of the outlet of a stage N. In some embodiments, a concentrate flows out of the outlet of a stage N. In some embodiments, purified water flows out of the outlet of a stage N. In some embodiments, brine flows out of a stage N.

In one embodiment, the stages operate in parallel. In one embodiment, the stages comprise a first chamber and a second chamber separated by the semipermeable membrane. Examples of membranes include but are not limited to, ion exchange membranes, monovalent selective cation exchange membranes, monovalent selection anion exchange membranes, low salt rejection reverse osmosis membranes, reverse osmosis membranes, standard seawater reverse osmosis membrane, normal osmosis membranes, forward osmosis membranes, nanofiltration membranes, semi-transparent membranes, and ultrafiltration membranes.

The system feed source input may comprise a feed stream or feed. The feed stream or feed may comprise any type of fluid. In particular, the fluid may comprise seawater, brackish groundwater, wastewater, or recycled water from any one of the stages in the system. In one embodiment, the feed stream is a concentrate. The feed stream may comprise any type of cation and anion. Exemplary cations and anions include, but are not limited to calcium, aluminum, magnesium, sodium, potassium, strontium, barium, ammonia, carbonate, sulfate, chloride, nitrate, boron, silicon dioxide, and iron. In one embodiment, the feed stream comprises salts such as sodium chloride (NaCl), potassium chloride (KCl), magnesium chloride (MgCl₂), magnesium carbonate (MgCO₃), magnesium sulfate (MgSO₄), calcium chloride (CaCl₂)), calcium sulfate (CaSO₄), calcium carbonate (CaCO₃), potassium acetate (KAc) or calcium magnesium acetate (CaMgAc).

In a particular embodiment, the fluid at any one of the stages is saline. In various embodiments, the salinity of the fluid is in the range of 1 (g/L) to 500 (g/l). In one embodiment, the salinity of the fluid is between 50 (g/L) and 400 (g/L). In one embodiment, the salinity of the fluid is between 100 (g/L) and 300 (g/L). In one embodiment, the salinity of the fluid is at least 200 (g/L).

The stages described herein may comprise any suitable hollow vessel appropriate for transportation of fluid. In one embodiment, the vessels are tanks. In one embodiment, the vessels are pipes. In one embodiment, the vessels are reservoirs. In one embodiment, the vessels are barrels. In one embodiment, the vessels are containers. In some embodiments, the vessel is a hollow pressure vessel suitable to house pressure-driven membrane elements. In some embodiments, the vessel comprises connections for a feed/brine inlet and an outlet for permeate that connects to the membrane element in the vessel.

Suitable material for the vessels may comprise any material known in the art including but not limited to organic polymers, inorganic polymers, homopolymers, copolymers, thermoplastics, thermosets, glass, quartz, ceramic, silica, alloy, metal alloy, stainless-steel, stainless-steel alloy, aluminum, aluminum alloy, aluminum oxide, copper, copper, alloy, titanium, titanium alloy, brass, plastic, or any combination thereof. Exemplary plastics include, but are not limited to, polyolefins, polyethylene, high-modulus polyethylene (HMPE), polypropylene, polybutylene, polybutene, polybutadiene, polybutylene terephthalate (PBT), polyethylene terephthalate (PET), 30 polytetrafluoroethylene (PTFE), polyvinylidene fluoride (PVDF), polycyclopentadiene (PCP), hydrogenated polycyclopentadiene (HCPC), polyetherimide (PEEK), polystyrene (PS), polyurethane (PU), polycarbonate (PC), polyacrylate, polymethacrylate, poly(methyl) methacrylate, polyoxymethylene, polylactic acid, polyether ether ketone, polyvinyl ether, polyvinyl chloride (PVC), chlorinated polyvinyl chloride, acrylonitrile butadiene styrene (ABS), polyethylene vinyl acetate (PEVA), styrene-butadiene copolymer, fluorinated polymer, and combinations thereof. In some embodiments, the material may be the same throughout the slag reactor, or the material may be varied to accommodate various specifications, such as transparency for monitoring or to meet requirements for the fluid to move slowly and/or quickly.

In one embodiment, the vessels described herein are connected to valves to control fluid levels and brine flows (RVi). In one embodiment, the valves are drain valves. In one embodiment the valves are venting valves. In one embodiment, the valves are shut-off valves. In one embodiment, the valves are transfer valves. In one embodiment, the valves are pressure relief valves. The valves may comprise any type of valve known in the art which include, but are not limited to, tee valves, ball valves, butterfly valves, diaphragm valves, gate valves, pinch valves, piston valves, plug valves, globe valves, needle valves, swing check valves, multi-port valves, float valves, foot valves, knife gate valves.

In various embodiments, the vessels have a circular, rectangular, triangular, elliptical, or rectilinear cross-section. In one embodiment, the vessels have a uniform cross-section area. In one embodiment, the cross-sectional area is substantially the same along the length of the reactors. In one embodiment, the vessels have a non-uniform cross-section area. In one embodiment, the cross-sectional area is not the same along the length of the vessels.

In one embodiment, a pump may be employed to drive the feed stream through all or parts of the system. In a particular embodiment, a pump may be applied across one or more of the stages which returns a recycle stream from the outlet of stage N to the feed inlet of stage N. In one embodiment, the magnitude of the total flow into the stage N membrane elements exceeds the minimum requirements by the membrane manufacturer. In one embodiment, a booster pump is used to pressurize the permeate of a low salt rejection reverse osmosis membrane. In one embodiment, the system comprises high pressure pumps. In one embodiment, the system comprises booster pumps. In one embodiment, the system comprises recirculation pumps. In one embodiment, the LSRRO stage further comprises a pump configured to boost the pressure of and to recirculate a portion of a concentrate output by the LSRRO stage to the input of said LSRRO stage.

In a particular embodiment, LSRRO stage 104 further comprises a booster pump 106 configured to boost the pressure of at least a portion of a permeate output by the LSRRO stage 104 to the input of an upstream LSRRO stage 104 or to the SWRO stage 105. In one embodiment, the system comprises a centrifugal pump.

In some embodiments, the system comprises a submersible pump. In some embodiments, the system comprises a positive displacement pump. In some embodiments, the pump is a screw pump. In some embodiments, the pump is a reciprocating pump. In some embodiments, the pump is a radial piston pump. In some embodiments, the pump is a hydraulic pump. In some embodiments, the pump is a rotary vane pump. In some embodiments, the pump is a piston pump. In some embodiments, the pump is an axial flow pump. In some embodiments, the pump is a gear pump. In o some embodiments, the pump is a plunger pump. In some embodiments, the pump is a dynamic pump. In some embodiments, the pump is a diaphragm pump. In some embodiments, the pump is a lobe pump. In some embodiments, the pump is a gear pump. In some embodiments, the pump is a metering pump. In some embodiments, the pump is a vacuum pump. In some embodiments, the pump is a peristaltic pump. In some embodiments the stages comprise a power source that can be used to operate the pumps and monitoring equipment in order to operate the system and vessels discussed herein. In some embodiments, a pump is not required, and flow of fluid is based on gravity.

In a particular embodiment, the LSRRO stage 104 further comprises a pressure exchanger 107 configured to recirculate at least a portion of a permeate output by the LSRRO stage 104 to the input of an upstream LSRRO stage 104 or to the SWRO stage 105. In one embodiment, the system 100 comprises a pressure exchanger 107 installed between stages n and n−1 which reduce energy requirements and provide a volume balance. In one embodiment, the permeate of stage N is fed into the inlet A of a pressure exchanger and is pressurized and exits from outlet B of the pressure exchanger and is fed into the feed source input of stage N−1.

In some embodiments, a pressure exchanger transfers water to a feed source input of any upstream or downstream stage. In some embodiments, a concentrate output from stage N is fed into the pressure exchanger at an inlet and exits from the outlet of the pressure exchanger at atmospheric pressure after transferring its energy to the permeate stream of stage N. In some embodiments, a pressure exchanger is used to pressurize a permeate of a LSRRO membrane or SWRO membrane before permeate enters a standard high salt rejection module. In one embodiment, the system operates multiple pressure exchangers in parallel. In one embodiment, the system operates multiple pressure exchangers in series.

In a particular embodiment, the first stage is low salt rejection reverse osmosis membrane combined with a standard high salt rejection module. In one embodiment, the permeate of a low salt rejection reverse osmosis membrane is fed into one or more standard high salt rejection modules. In one embodiment, a pressure exchanger is used to pressurize the permeate of a low salt rejection reverse osmosis membrane in order to calibrate it to the operating pressure of the standard high salt rejection module. In one embodiment, the concentrate from the standard high salt rejection module is blended with the stream in the system feed tank. In one embodiment, purified water is collected from the standard high salt rejection module. In one embodiment, the permeate from a stage with a low salt rejection reverse osmosis membrane is fed into a stage with a standard high salt rejection module. In a particular embodiment, the concentrate of the standard high salt rejection module is passed through a pressure exchanger and the reject is returned to the original feed of the low salt rejection reverse osmosis cascade after transferring its energy through the pressure exchanger into the feed of the stage with a standard high salt rejection module before the high-pressure pump.

In one embodiment, antiscalant is fed to the permeate stream in the last stage. In one embodiment, a low molecular weight antiscalant is fed to the concentrate stream in the last stage so that the antiscalant crosses the membrane barrier into the permeate. Exemplary scalants include but are not limited to polyacrylic acids, carboxylic acids, polymaleic acids, organophosphates, polyphosphates, phosphonates, anionic polymers, phosphonates such as 1-hydroxyethylidene 1,1-diphosphonic acid (HEDP) or other proprietary silica anti-scalants such as Vitec 4000 (Avista Technologies Inc) Genesys SI (Genesys International Ltd), calcium carbonate, calcium sulfate, barium sulfate, strontium sulfate, calcium fluoride, iron, colloidal material, silica and other organic contaminants.

### Method of Purification

In one aspect, the present invention relates in part to a method of purifying contaminated fluid. The method comprises the steps of providing any of the reverse osmosis systems 100 described herein; inputting a high salinity fluid into the feed source input 101; increasing the pressure of the high salinity fluid via the high pressure feed pump; performing reverse osmosis via the RO cascade 103; and collecting at least one of a concentrate and a permeate.

In some embodiments, the method providing the reverse osmosis system 200; inputting a high salinity fluid into the feed source; increasing the pressure of the high salinity fluid via a pump 205 to create an intermediate stream 214; increasing the pressure of the intermediate stream via the energy recovery device 206; performing reverse osmosis on the intermediate stream via the SWRO/LSRO stage 202/204 to create a concentrate 215 and a permeate 218; and collecting the permeate. In some embodiments, the method further comprises recirculating the concentrate via the energy recovery device to the high pressure feed pump while recovering its mechanical energy. In some embodiments, the method further comprises introducing the concentrate to the LSRRO stage.

The process may be operated in any manner desired, e.g. as continuous, semi-continuous. The process may be controlled using known equipment and control schemes. For example, hydraulic retention time, desired feed rates of input fluid, anti-scalants, etc. may be determined by routine experimentation. In one embodiment, the flow rate in the process is controlled by setting a pump to the desired flow rate. In one embodiment, the ratio of volume or flow rate of fluid into the feed stream of a stage N to the volume or flow rate of the concentrate feed of stage N is 4 or higher. In one embodiment, the ratio of volume or flow rate of fluid into the permeate of a stage N to the volume or flow rate of the concentrate feed of stage Nis 4 or higher.

The method described finds use for the desalination of fluid. The reverse osmosis system may comprise a feed source input 101/201/208. The feed source input may comprise any type of fluid. In particular, the fluid may comprise seawater, brackish groundwater, wastewater, or recycled water from any one of the stages in the system. In one embodiment, the feed stream is a concentrate. The feed stream may comprise any type of cation and anion. Exemplary cations and anions include but are not limited to calcium, aluminum, magnesium, sodium, potassium, strontium, barium, ammonia, carbonate, sulfate, chloride, nitrate, boron, silicon dioxide, and iron. In one embodiment, the feed stream comprises salts such as sodium chloride (NaCl), potassium chloride (KCl), magnesium chloride (MgCl₂), magnesium carbonate (MgCO₃), magnesium sulfate (MgSO₄), calcium chloride (CaCl₂)), calcium sulfate (CaSO₄), calcium carbonate (CaCO₃), potassium acetate (KAc) or calcium magnesium acetate (CaMgAc).

In one embodiment, the stages operate in parallel. In one embodiment, the stages comprise a first chamber and a second chamber separated by the semipermeable membrane. Examples of membranes include but are not limited to, low salt rejection reverse osmosis membranes, reverse osmosis membranes, standard seawater reverse osmosis membrane, normal osmosis membranes, forward osmosis membranes, nanofiltration membranes, semi-transparent membranes, and ultrafiltration membranes.

In one embodiment, the step of pumping the feed source input through the stages desalinizes the fluid. In one embodiment, the step of pumping the fluid from the vessel to a stage with a low salt rejection reverse osmosis membrane is done by a high-pressure feed pump. In one embodiment, the step of pumping the fluid through the low salt rejection membrane desalinizes the fluid. In one embodiment, the permeate is recirculated with a booster pump or a recirculation pump. In one embodiment, the permeate is pumped to the standard high salt rejection module with a high-pressure feed pump. In one embodiment, a pressure exchanger, with the help of a booster pump, is used to pressurize the permeate of a low salt rejection reverse osmosis membrane before it enters the standard high salt rejection module.

In one embodiment, antiscalant is fed to the permeate stream in final stage. In one embodiment, a low molecular weight antiscalant is fed to the concentrate stream in the last stage so that the antiscalant crosses the membrane barrier into the permeate. Exemplary scalants include but are not limited to polyacrylic acids, carboxylic acids, polymaleic acids, organophosphates, polyphosphates, phosphonates, anionic polymers, phosphonates such as 1-hydroxyethylidene 1,1-diphosphonic acid (HEDP) or other proprietary silica anti-scalants such as Vitec 4000 (Avista Technologies Inc) Genesys SI (Genesys International Ltd), calcium carbonate, calcium sulfate, barium sulfate, strontium sulfate, calcium fluoride, iron, colloidal material, silica and other organic contaminants.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore are not to be construed as limiting in any way the remainder of the disclosure.

It is the purpose of this invention to overcome the twin barriers to near liquid zero discharge (near-ZLD) of saline streams using non-thermal membrane processes that include at least one pressure driven membrane process. These two barriers are osmotic pressure and the accumulation of scaling species in the concentrate that can scale and foul the pressure driven membrane surface. While the process of low salt rejection RO cascades (LSRRO) can overcome high osmotic pressure limitations, scaling species in the brine being treated can reach concentrations that would result in very high supersaturations leading to precipitation and scaling of the membrane surface. By first treating the feed brine with monovalent selective electrodialysis (MSED), a secondary brine at even higher concentration can be fed to the LSRRO process in which the concentration of scaling species (divalent salts of sulfate, silica, and calcium carbonate) is greatly reduced relative to the initial feed brine and a diluate is produced that can be mixed with RO permeate streams to produce a water that can be used for both potable and agricultural purposes.

### Example 1: Cascade of Low Salt-Rejection RO Membranes (LSRRO)

A way to overcome the issue of osmotic pressure of reverse osmosis (RO) concentrates and other industrial brines is called low salt-rejection RO (LSRRO) in which downstream RO stages use membranes with substantially lower salt rejections and the permeate from a downstream stage is fed back to the feed of the previous upstream stage. This reduces the required applied pressure to generate a positive net driving pressure for stage (NDPi) to drive flux by three different mechanisms as illustrated in the following equation A:

$${NDP}_{i} = Δ {P}_{i} - {σ}_{i} Δ {π}_{i} = Δ {P}_{i} - {σ}_{i} {R}_{i} \text{?} \qquad eq . A$$

$$\text{?} \text{indicates text missing or illegible when filed}$$

where P is the hydraulic pressure. The stage reflection coefficient (o) and the stage rejection (R) are significantly less than 1 while the average bulk concentration on the feed side is less than it would be without applying the cascade approach. Simple modelling using a two-parameter model (assuming reflection coefficient is unity) has already been carried out and shown that very high salinities can be reached (12-20% TDS) with modest energy consumptions (4-7 kWh/m³) (Wang, Z. et al., Water Res., 170, 115317, 2020; Du, Y., et al., Water Res., 209, 2022).

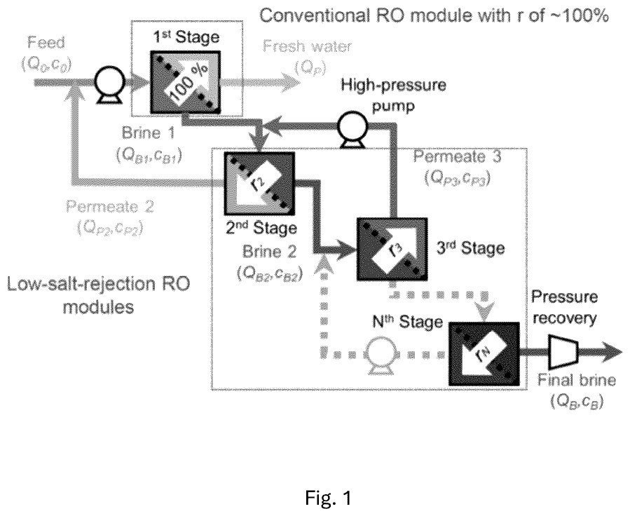

An idealization of the approach is illustrated in FIG. 1. Very large flow brine streams can be accommodated with this approach. In other cases, the flows in the final brine being concentrated can be quite low so that a once-through flow arrangement can require special arrangements to keep flows above the minimum manufactured recommended minimal flows so that concentration polarization will not be excessive, leading to poorer salt rejection and potential scaling issues. Another necessity is that a minimum of N−1 high pressure pumps are required for an n-stage cascade.

There will be a problem in that any scaling species fed to the LSRRO cascade will be concentrated in the final LSRRO brine by the volume concentration factor effected by the LSRRO cascade. For example an RO concentrate that is 20,000 mg/L TDS that contains 500 mg/L calcium, 500 mg/L of sulfate, 1500 mg/L of bicarbonate and 1 mg/L of barium, that is further concentrated 5-fold in the LSRRO cascade to reach 100,000 mg/L TDS will now contain 2500 mg/L of calcium, 2500 mg/L of sulfate, 7500 mg/L of bicarbonate and 5 mg/L of barium. This will be highly supersaturated with respect to both calcium sulfate and barium sulfate and to calcium carbonate, and may not be controllable by standard antiscalants. A brackish groundwater was desalinated by reverse osmosis and because of the presence of silica in the raw brackish groundwater, the recovery in the RO step was only 82%. The composition of the brackish water feed and RO concentrate are provided in Table 1.

TABLE 1
Composition of the brackish water feed and RO concentrate; Conductivity
of RO Feed: 2850 μS/cm; Conductivity of RO Conc: 15700 μS/cm;
pH of RO Feed: 7.2; Temperature of RO Feed: 21-27° C.

| | RO Feed (g/m³) Conc. | RO conc. |
|---|---|---|
| Species | (mg/L) | (g/m³) |
| Ca | 120 | 666 |
| Mg | 76 | 421 |
| Na | 346 | 1889 |
| K | 4.9 | 27 |
| Sr | 1.97 | 10.9 |
| Ba | 0.156 | 0.87 |
| NH4 | 0.02 | 0.11 |
| HCO3 | 304 | 1677 |
| SO4 | 92 | 509 |
| Cl | 701 | 3868 |
| NO3 | 62 | 344 |
| B | 0.43 | 2.06 |
| SiO2 | 30 | 161 |
| Fe | 0.019 | 0.11 |

If high pressure RO desalination were used to concentrate this stream to 200,000 mg/L the final osmotic pressure to overcome would be 130 bar, far beyond the reach of standard RO systems but well within the capability of LSRRO. However, if the RO concentrate were fed directly to the LSRRO, the final silica concentration would be 4655 mg/L which is ˜40 times the saturation concentration.

The use of monovalent selective electrodialysis (MSED) produces a concentrate stream that is significantly lower in divalent content and silica content. By combining MSED and LSRRO the shortcomings of both (limitations of concentrate concentration for MSED, and scaling issues with LSRRO) can be overcome (Sata, T. et al., J. Memb. Sci., 93, 117-135, 1994; Cohen, B. et al., Desalination, 431, 126-139, 2018; Ahdab, Y. D. et al., ACS EST Water, 1, 1, 117-124, 2021).

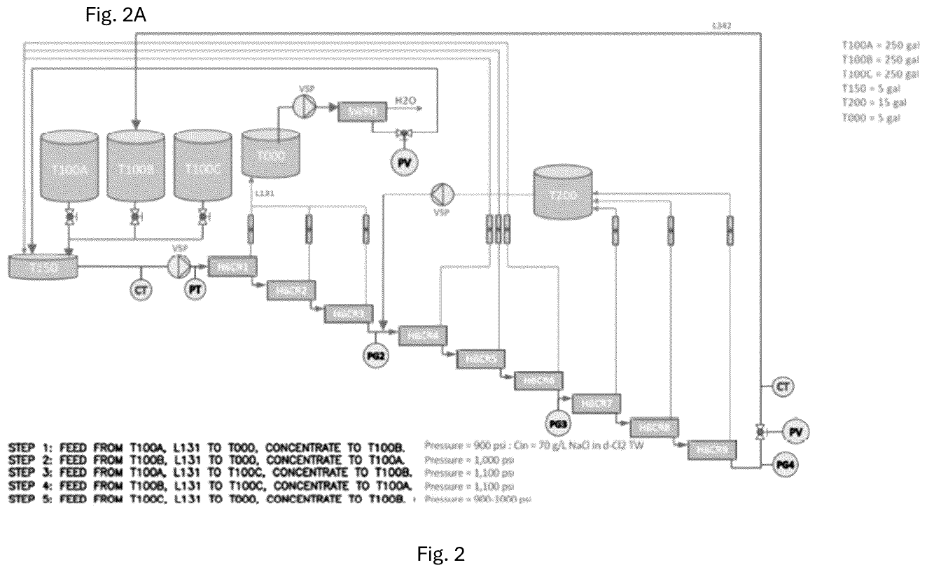

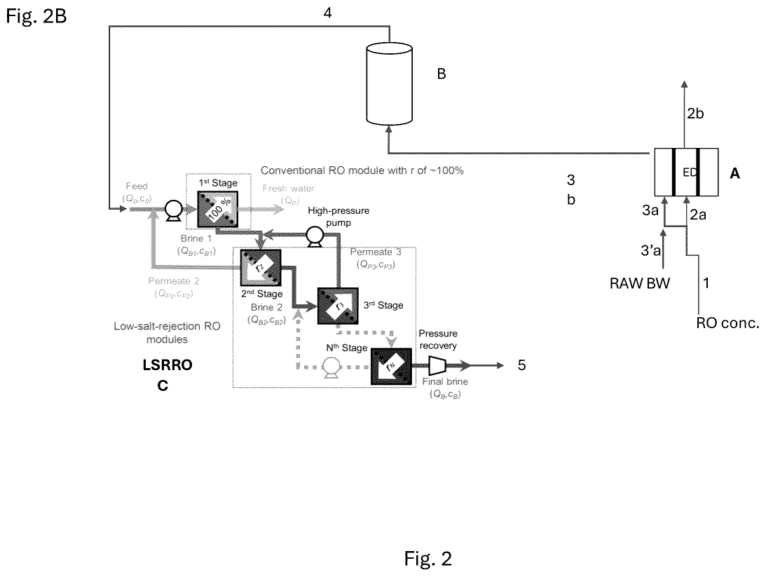

FIG. 2 shows a process scheme where hydraulic limitations can be overcome in an LSRRO cascaded by using a modified batch approach. This arrangement can be done with lower flows by concentrating in a hybrid batch manner in which the outlet of the last stage is stored in an intermediate container and then it is run through the cascade again. This effectively allows a 3-stage system to operate like an 3*N stage system, wherein the n is the number of times that the concentrate of the third stage is returned to the feed tank of the cascade. The control requirements on such an arrangement can be challenging because of the need to keep balance in the operating tanks (T150 and T200 of FIG. 2A).

FIG. 2B is a typical process flow train that incorporates both MSED and LSRRO in the treatment of an RO concentrate. The saline feed stream (1) originates from RO concentrate or other saline stream from industry and contains scaling ions. It is split into two streams to feed to the diluate (1a) and concentrate side (1b) of the electrodialysis stack (A) equipped with pairs of alternating monovalent selective cation exchange membrane (CEM) and monovalent selective anion exchange membrane (AEM).

The MSED stack removes predominantly monovalent ions from diluate stream to produce a diluate product stream of reduced salinity but retaining most of the divalent ions and practically all the silica that was in the stream. The concentrate exit stream that received the ions that cross the membranes in the electrodialysis (ED) stack is concentrated with respect to the original saline feed stream. Its divalent content depends on the CEM and AEM selectivity and the extent of removal of the monovalent ion (particularly sodium chloride). If monovalent selectivity is high enough (and thus divalent cation content low enough) then it can be fed directly to the LSRRO cascade where it is concentrated to its highest level as LSRRO concentrate. If the divalent content in the stream is still somewhat high, then this can be dealt with by feeding it to a scaling ion scavenging process (B) where the divalent ions are reduced. The outlet with reduced calcium content can then be fed to the LSRRO (C). Embodiments of this process can include cation exchange columns for removal of divalent cations, or a crystallization process (fluidized bed, mixer settler crystallizer, etc.) to remove calcium carbonate or calcium fluoride or other scaling species that may be slightly higher than saturated in stream. However the size of this process will be greatly reduced since the bulk of such scaling species remain in the diluate product stream.

Since the feed to the concentrate side of the MSED stack is already concentrated by the previous RO process, there will be an elevated concentration of scaling species in the ED concentrate even before more ions are pushed into the concentrate during the ED process. This means a higher level of such scaling species in stream with which the LSRRO will have to contend. A way of reducing this load, is to use raw groundwater (3′a) or some other low ion content water as the receiving solution fed to the ED concentrate side as stream. This can greatly reduce the scaling ion load, especially when the MSED is highly selective and the initial concentrate feed strongly influences the final scaling species content.

Many additional variations can be made on the principles enunciated here. The rest of the description will provide illustrations of these principles.

If a RO concentrate as defined in Table 1 is fed to a process flow stream as described in FIG. 2B, to a monovalent selective electrodialysis unit in which the fraction of stream 1 that is split to stream 3a is defined by Y_{ED} (=1−Q₃ₐ/Q₁) and the extent of sodium removal from the diluate inlet stream is defined as:

$$\text{?} ≡ \frac{{[ {Na}^{+} ]}_{2 a} - {[ {Na}^{+} ]}_{2 b}}{{[ {Na}^{+} ]}_{2 a}} \qquad eq . 1$$

$$\text{?} \text{indicates text missing or illegible when filed}$$

In which the subscripts on the sodium concentrations refer to streams in FIG. 2′, then one can calculate the recovery required in the LSRRO step (=Y_{LSRRO}) to reach 2.2 M Na+ in the LSRRO concentrate by conducting the following mass balance (eq. 2):

$${{Q}_{b , 5} ( {C}_{b , 5} )}_{j} = {Q}_{1} {C}_{1 , j} - {Q}_{2 b} {C}_{2 b , j}$$

where:
Q_{2b}Q_{2b,j}=Y_{ED}Q₁C₁·(1−r_{Na}_{⁺}) if RO brine fed to concentrate side
Q_{2b}C_{2b,j}=Q₁C₁·(1−r_{Na}_{⁺}) if raw water is fed to the concentrate side

Q refers to the volumetric rate of the flow. Y_{ED} refers to the amount of product water (diluate) as a fraction of the feed water (RO concentrate) and the subscript refers to the ion species j. The explicit definitions of Y are given in the equation 3 below and for case where raw water is fed to the concentrate side, equation 4 gives the concentration factor obtained in the MSED step:

$$( {Y}_{ED} ) ≡ \frac{{Q}_{2 b}}{{Q}_{1}} ( 1 - {Y}_{LSRRO} ) ≡ \frac{{Q}_{5}}{{Q}_{4}} ( \text{?} ) ≡ \frac{{Q}_{1}}{\text{?}} \qquad eq . 3$$

$$\text{?} \text{indicates text missing or illegible when filed}$$

Then:

$$\frac{{C}_{3 b , j}}{\text{?}} = 1 + \frac{{Y}_{ED} {r}_{j}}{( 1 - {Y}_{ED} )} = \frac{1}{( 1 - {Y}_{ED} )} - \frac{{Y}_{ED} ( 1 - {r}_{j} )}{( 1 - {Y}_{ED} )} \qquad eq . 4$$

$$\text{?} \text{indicates text missing or illegible when filed}$$

When RO concentrate is fed to the concentrate side the expression in the first line of equation 5 is obtained, and when raw water is fed to concentrate side, the expression in second line of equation 5 is obtained and applied to sodium ion (Na+):

$$\frac{{C}_{b , 5}}{{C}_{1}} = ( \frac{{C}_{b , 5}}{{C}_{3 b}} ) ( \frac{{C}_{3 b}}{{C}_{1}} ) \approx \frac{1}{1 - {Y}_{LSRRO}} \cdot \frac{1}{1 - {Y}_{ED}} ( 1 - {Y}_{ED} + {Y}_{ED} {r}_{{Na}^{+}} ) \qquad eq . 5$$

$$\frac{{C}_{b , 5}}{{C}_{1}} = ( \frac{{C}_{b , 5}}{{C}_{3 b}} ) ( \frac{{C}_{3 b}}{{C}_{1}} ) \approx \frac{1}{1 - {Y}_{LSRRO}} \cdot \frac{1}{1 - {Y}_{ED}} ( 1 - {Y}_{ED} + {Y}_{ED} {r}_{{Na}^{+}} )$$

When raw water fed to concentrate side of MSED.

Where j refers to the particular aqueous species in the stream. If no scaling species removal step is applied then one can set C4=C3b.

Then one can write to reach a target concentration of sodium ion in the LSRRO concentrate:

$$[ {Na}^{+} \text{?} = {[ N \text{?} ]}_{4} \frac{{Q}_{4}}{{Q}_{5}} = {[ {Na}^{+} ]}_{4} \frac{1}{1 - {Y}_{LSRRO}}$$

$$\text{?} \text{indicates text missing or illegible when filed}$$

Applying equations 1-5 can generate the profiles of required recovery in the LSRRO step to get a concentration of 2.2 M sodium ion in the final stream. For many compositions, depending on the MSED selectivity, this will give a final concentrate which has an osmotic pressure of 120-160 bar. The required recovery in the LSRRO step as a function of the recovery in the ED step and the extent of sodium ion removal from the diluate stream.

Similarly using the equations 1-5 for calculating calcium concentration in the final LSRRO brine stream as a function of the cation exchange membrane selectivity of sodium over calcium

$$( {P}_{Ca 2 +}^{Na +} ≡ \frac{{r}_{Na +}}{{r}_{Ca 2 +}} )$$

its possible to calculate calcium carbonate scaling potential for an MSED recovery rate of 80%.

Even for the worst case (sodium removal in ED step of only 50% and Sodium/Calcium selectivity of only 4 (C_{5, Ca}²⁺=420 meq/L), the final LSRRO brine has a calculated LSI of 2.4 for calcite which can be controlled by antiscalant chemicals.

If a calcium removal step involving a cation exchange column, then the calcium level can be reduce by 80-90% and then the highest calcium level in the LSRRO concentrate will not exceed 45-90 meq/L. The demands on such a column will be <25% of those if the same column were applied to the RO concentrate because at a sodium/calcium selectivity of 4 in the ED step, when 90% of sodium is removed, only 22.5% of the calcium is moved to the concentrate stream.

If the same composition of stream 1 is used, but raw groundwater is used as concentrate feed instead of RO concentrate, then the concentration of scaling ions can be reduced even further. The options of feed stream from the RO concentrate is compared to feed stream from the raw groundwater. As shown in the Table 2 below, silica levels in the LSRRO concentrate are much lower when the groundwater is used as the MSED feed. As can be seen, the level of silica in the stream is only near or below the saturation limit of silica (˜120 mg/L) when raw groundwater is used as stream and YED is at 85% or higher.

TABLE 2
Silica levels (mg/L) in LSRRO concentrate as function
of ED recovery and source of feed to ED concentrate.

| | ED conc source | |
|---|---|---|
| YED | RO Conc | Raw Feed |
| 0.75 | 1258 | 226 |
| 0.8 | 1012 | 182 |
| 0.85 | 763 | 137 |
| 0.9 | 512 | 92 |
| 0.95 | | 46 |

### Example 2: Applying Recirculation Pumps

A different realization can be provided in which a truly once-through steady-stage operation can be realized even/especially in small systems by inserting recycle pumps within each stage (FIG. 3). The required minimum feed flow velocity across the membrane surface (to avoid severe concentration polarization) is realized with the booster/recirculation pumps of each stage without this being dependent on the feed flows into the stage and flow rates of streams leaving the stage.

### Example 3: Applying Pressure Exchangers (PX)

A further realization can be obtained by using pressure exchangers (PX) instead of high-pressure pumps to move permeate stream from stage N to the feed stream of stage N−1 (FIG. 4). The system reject stream can operate multiple PXs in series or in parallel. This has the double advantage of reducing the energy requirements of the process and providing a volume balance that is not easily achieved in conventional systems with tank 200 in FIG. 2. A particular illustration of these two embodiments can be found in FIG. 4. In FIG. 4, one has small booster pumps (denoted booster/recirculation) that increase the pressure from the brine pressure of stage N to the feed pressure of stage N. This difference in pressure is a result of the frictional pressure drop along the membrane elements in stages N. In yet another embodiment, the Nth booster/recirculation pump might transfer water to the feed stream of stage N−1, or N−2, or any upstream or downstream stages.

In FIG. 4, the first stage (denoted LSRRO1) uses a standard seawater RO (SWRO) membrane element or plurality of elements to generate product water in the permeate stream as originally envisaged in FIG. 1. This will be adequate when the feed stream salinity does not exceed 0.6-0.8 M NaCl (36,000-48,000 mg/L equivalent TDS) as the SWRO membrane/s will operate at reasonable applied pressures. However, if the initial feed is especially saline (>100,000 mg/L), then the first stage might not be able to operate at moderate pressures, even with the dilution occurring due to the recycling of the permeate from stage 2.

### Example 4: Utilizing an External SWRO Stage

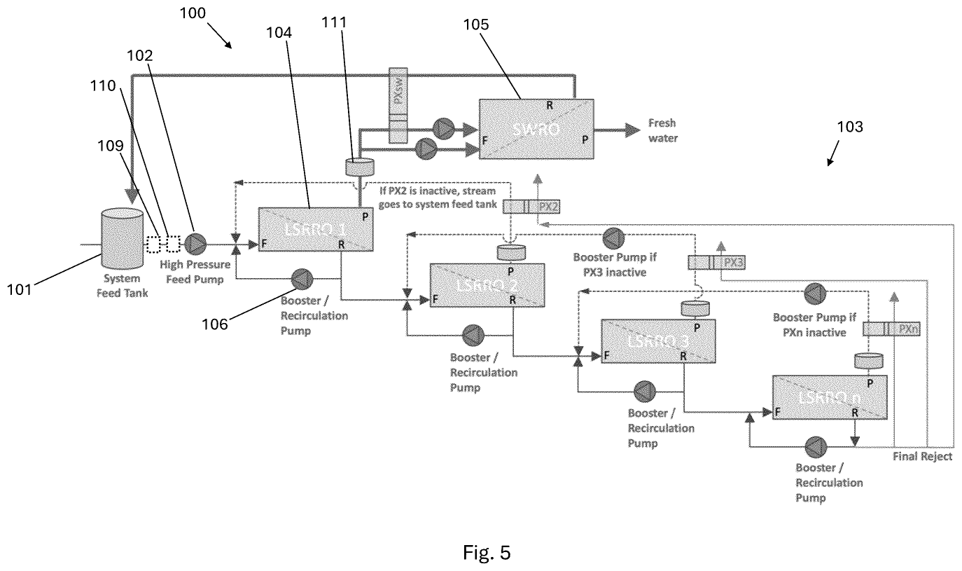

A further example has been envisaged as illustrated in FIG. 5 wherein the LSRRO1 stage also has relatively lower salt rejection (<80%) and the permeate of the LSRRO1 is fed to a standard SWRO stage/s containing one or more SWRO membrane elements. In the SWRO stage shown in FIG. 5, a pressure exchanger is used for pressurizing the LSSRO1 permeate to the operating pressure of the SWRO module with the help of a small booster pump. The SWRO concentrate is then blended with the original feed that is introduced at the top of the LSRRO cascade.

Since there is a risk of scaling minerals on the different stages of the LSRRO cascade, normal practice would be to dose antiscalant on the feed/high-pressure side of the LSRRO cascade. However, because the membranes are low rejection, they may leak scaling species into the permeate and there can be scaling potential there as well. If the scaling species are partially passed but the antiscalants (which are often polymers of 1000-2000 Da) are completely rejected, then scaling waters on the permeate side could plug the back side of the membrane. Therefore, an additional novel step will be to feed antiscalant to the permeate of the last stage to protect the permeate side of the cascade. Alternatively, a low molecular weight antiscalant (C1-C3) can be fed to last stage feed that can be expected to partially pass the membrane and get into the last stage permeate.

### Example 5: Implementing Flexible Reverse Osmosis Stages

Low-salt-rejection reverse osmosis (LSRRO) applies a cascade of RO stages to achieve high water recoveries from brines, while overcoming high osmotic pressures. When brine volumes are reduced, the final concentrate flow rates may fall below the operating limits of the RO modules. Recycling brine within each stage allows to overcome this limitation, and incorporating pressure exchangers reduces the energy penalty associated with the recycle stream. Following this principle, a small pilot LSRRO system based on recycle with pressure intensifiers allowed to concentrate 45 L/h of synthetic brackish water reverse osmosis (BWRO) brine (26.9-33.3 g/L NaCl) threefold. Importantly, hydraulic limitations that may render LSRRO implementation challenging were overcome by adopting a flexible process configuration. Notably, only three stages, one equipped with one 2540 element—a seawater reverse osmosis (SWRO) membrane, a TS80 nanofiltration membrane, and a chlorinated SWRO membrane—were needed to achieve target water recoveries and, likewise, desired concentration factors. Final salt concentrations exceeded those commonly attainable with conventional RO systems. However, rejections for the modules were not optimal to realize the full concentration potential of the staged design. Further work is being conducted to demonstrate viable pathways for improving system performance metrics.

Minimizing brine volumes is a critical challenge in reverse osmosis desalination and industrial wastewater treatment. Brine management represents one of the most pressing sustainability barriers to the broader deployment of membrane-based separation technologies. High-salinity waste streams pose environmental concerns and represent a loss of potentially recoverable water and resources. Consequently, there is a growing emphasis on developing strategies that enable higher water recovery while maintaining acceptable system performance and cost. (Tong T. et al., Nat Rev Clean Technol. 2025 March; 1 (3): 185-200; Wu J, Hoek E M, Current Opinion in Chemical Engineering. 2025 Mar. 1, 47:101079; DuChanois R M et al., Nat Water. 2023 January; 1(1): 37-46)

One promising approach for achieving high water recoveries from brines is LSRRO, which leverages RO membranes with intentionally reduced salt rejection characteristics to overcome osmotic pressure limitations. By operating under lower osmotic pressure differential across the membrane, LSRRO allows for high water permeation at higher salinity/recovery compared to conventional high-rejection RO systems. However, as water recovery increases and feed flow rates diminish, practical limitations emerge. Specifically, the flow along membrane elements can drop below the minimum levels specified by manufacturers, leading to operational instability and reduced membrane performance. (Du Y. et al., Journal of Membrane Science. 2023 Jul. 15; 678:121642; Wang Z. et al., Water Research. 2020 Mar. 1; 170:115317)

To address these hydraulic limitations, a recent study proposed a modified batch operating method that achieves modest recoveries (20-30%) in a single pass. Concentrate is fed into intermediate feed tanks, which guarantee a continuous feed supply through the LSRRO cascade until the target salinity is reached. In this process scheme, appropriate crossflow velocities are sustained, while achieving high water recovery. However, the design is complex with an extensive control structure and nine membrane elements and six operating tanks. While batch approaches offer a viable pathway to mitigate low-flow operation, they inherently involve intermittent operation, which can limit their practicality in large-scale or processes requiring continuous treatment. (Van Houghton B D et al., ACS EST Water. 2024 Nov. 8; 4 (11): 5089-104)

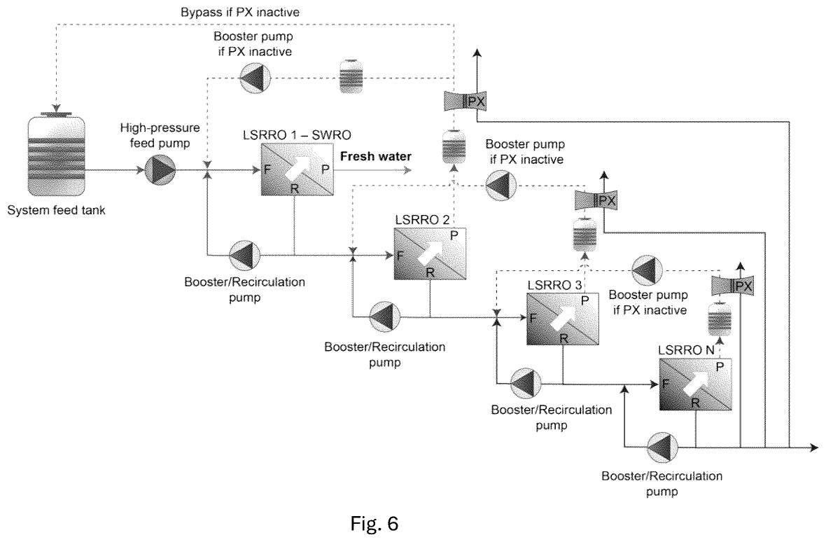

In pursuit of a once-through configuration that retains the hydraulic benefits of batch processes, proposed herein is a multi-stage RO system with internal recycle within each stage (FIG. 4 and FIG. 6). Such a staged-recycle design effectively decouples flow and recovery constraints, allowing for sustained operation across a wide range of salinities and recoveries. Examination of an individual stage (FIG. 7A) shows requirements of a booster pump for permeate and a recycle pump for concentrate recirculation. In addition, membrane elements with specific salt rejections must be used to optimize hydraulic pressure utilization and water recovery in the system. To accomplish this, either each stage must be operated at the pressure available from the reject of the previous stage, or interstage booster pumps must be installed. In the former case, maximum pressure must be provided at the inlet to the cascade. (Wang Z. et al., Water Research. 2020 Mar. 1; 170:115317; Atia A A, et al., Desalination. 2023 Apr. 1; 551:116407)

This process can be practically implemented using flexible RO (FLERO). FLERO incorporates pressure intensifiers to transfer and recover energy from recycle to feed streams composed of upstage concentrate and downstage permeate (FIG. 7B), with a single feed booster pump on each stage. Pressures are automatically adjusted based on the interacting salinities of each stage. As a result, control of the overall system is based strictly on control of the permeate and concentrate flows. The exceptional flexibility of this process configuration makes it particularly well-suited for high-recovery and brine-minimizing applications. (Lee T. et al., Desalination. 2019 Feb. 15; 452:123-31)

Reported herein is the design and operation of a novel staged-recycle LSRRO system employing the FLERO principle, treating synthetic NaCl brines and reaching final concentrate concentrations in excess of 10% TDS. The system demonstrates how internal recycle and pressure recovery can be integrated to achieve continuous, energy-efficient, and high-recovery operation, thereby advancing the goal of minimizing brine volumes in both desalination and industrial wastewater treatment contexts.

A three-stage LSRRO pilot was fabricated from three FLERO-type sub-systems (Osmosea Watermaker, Italy) connected as shown in FIG. 8A. FIG. 8B shows a photo of an exemplary module and system. The properties of the sub-systems for each stage are provided in Table 3. Each stage was equipped with flow meters on the concentrate and permeate streams (Arad Dalia), conductivity probes on the permeate and concentrate lines (Inno), and pressure sensors on the module inlet. The permeate rates for the modules were fixed for stages 1 and 2 and could be adjusted between 40 L/h and 65 L/h on the final stage.

TABLE 3
Properties of OsmoSea Watermaker units installed in LSRRO pilot.
Efficiencies (n) based on manufacturer specifications and
direct measurement.

| Stage | Model | Permeate flow (L/h) | η_{ERD} | η_{Pump} |
|---|---|---|---|---|
| 1 | NEW12 S 30 24VDC | 30 | 0.89 | 0.725 |
| 2 | NEW12 S 65 24VDC | 65 | 0.88 | 0.487 |
| 3 | NEW12 S 65 24VDC | 30-65 | 0.88 | 0.487 |

Each stage was equipped with a 2540 spiral wound membrane module with the properties provided in Table 4. Optional intermediate feed tanks (maximum 30 L each) were provided to feed stages 2 (T2) and 3 (T3) to allow for occasional lack of balance in the flow rates into and out of a stage. The tanks, therefore, were maintained at 20-30 L to adjust flow rates correspondingly. A feed tank (T1, 200 L) was installed to feed into the entire system. To avoid feed supply shortages, the system was operated in total recycle, with the final brine and the first stage permeate being returned to T1 (dashed lines on 8A). To minimize temperature fluctuations, a heat exchanger with a chiller was installed on the inlet to the feed pump of the third stage.

TABLE 4
Nominal characteristics of spiral wound 2540 modules installed in LSRRO
cascade.

| | | | | Test conditions |
|---|---|---|---|---|
| Stage | Module (Supplier) | A (LMH/bar) | R (%) | (C_{avg} @ Flux) |
| 1 | SWRO (Osmosea) | 1.0 | 99.9 | 32.1 g/L @ 21.6 LMH |
| 2 | TriSep TS80 (Mann-Hummel) | 3.2 | 87.4 | 47.9 g/L @ 20.4 LMH |
| | | 3.2 | 74.3 | 74.2 g/L @ 20.6 LMH |
| 3 | Chlorinated SWRO (BGU*) | 3.8 | 65.6 | 75.4 g/L @ 20 LMH |

*Original SWRO module supplied by Osmosea and treated at BGU with hypochlorite to reduce rejection.
R: salt rejection rate.
A: water permeability coefficient.

The feed tank (T1) was filled with sodium chloride solutions of different salinities (26.9, 29.2, and 33.3 g/L) and the intermediate tanks (T2 and T3) were filled with sodium chloride solutions of marginally higher salinities to reduce the time to reach steady state for the system. The composition of each stream was determined by argentometric analysis of chloride and/or from stream conductivity based on a calibration curve, with chloride concentration in the operating range. At least 100-200 L of feed were processed in each run (2-5 hours).

The concentrate control valves (RV1-RV3) were manually set to provide the required flow rate Qᵣᵢ out of each stage to maintain flow balance around each stage, and to set overall recoveries. The set points for concentrate flows were established according to the following equations based on the design system recovery, Y_{LSRRO}

$${Q}_{f} = \frac{{Q}_{p}}{{Y}_{LSRRO}} \qquad ( 1 )$$

$${Q}_{b} = {Q}_{r 3} = {Q}_{f} - {Q}_{p} \qquad ( 2 )$$

$${Q}_{r 2} = {Q}_{b} + {Q}_{p 3} \qquad ( 3 )$$

$${Q}_{r 1} + {Q}_{p 3} = {Q}_{r 2} + {Q}_{p 2} \qquad ( 4 )$$

In eqs. (1)-(4), Q_{f}, Q_{r,i}, Q_{p,i} denote to the feed flow into the cascade, and retentate and permeate flows into stage i, respectively. All streams are clearly labeled in 8A.

The permeate flows were fixed for stages 1 and 2 (Table 3) and could be manually set for stage 3. Intermediate stream concentrations were determined by the rejection properties of the membrane elements and the mass balance around each stage. Specific energy consumption (SEC) was calculated using:

$$SEC = \frac{1}{{q}_{bf}} {\sum }_{stages , i} {\dot{W}}_{P , i} = \frac{{Y}_{LSRRO}}{{q}_{p}} {\sum }_{stages , i} {\dot{W}}_{P , i} \qquad ( 5 )$$

where W_{P,i} corresponds to the power consumed by a single stage and is given by

$${\dot{W}}_{P , i} = \frac{Δ {P}_{f , i} {q}_{f , i} [ 1 - ( 1 - {Y}_{sp , i} ) {η}_{ERD} ]}{{η}_{pf , i}} \qquad ( 6 )$$

where ΔP_{f,i} corresponds to the feed pressure to stage i, Y_{sp,i} is the single-pass recovery of that stage, and η_{ERD} and η_{pf,i} are the efficiencies of the ERD and feed pump to the stage, respectively.

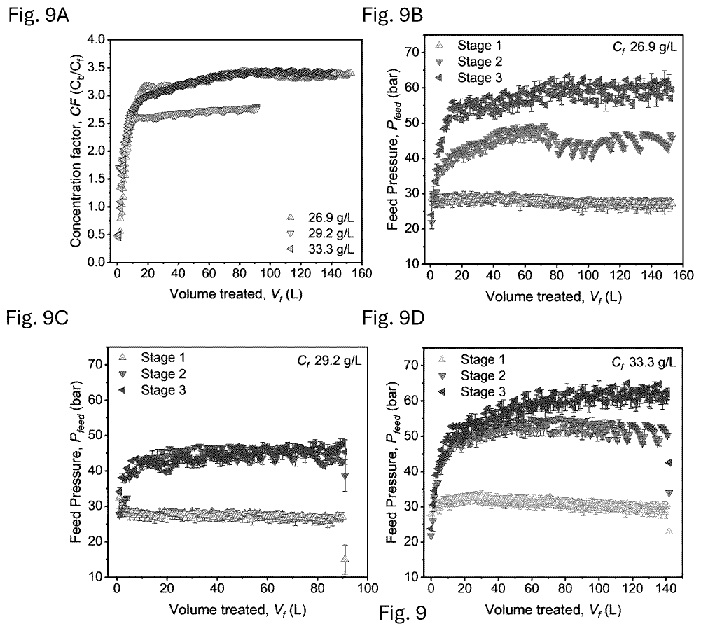

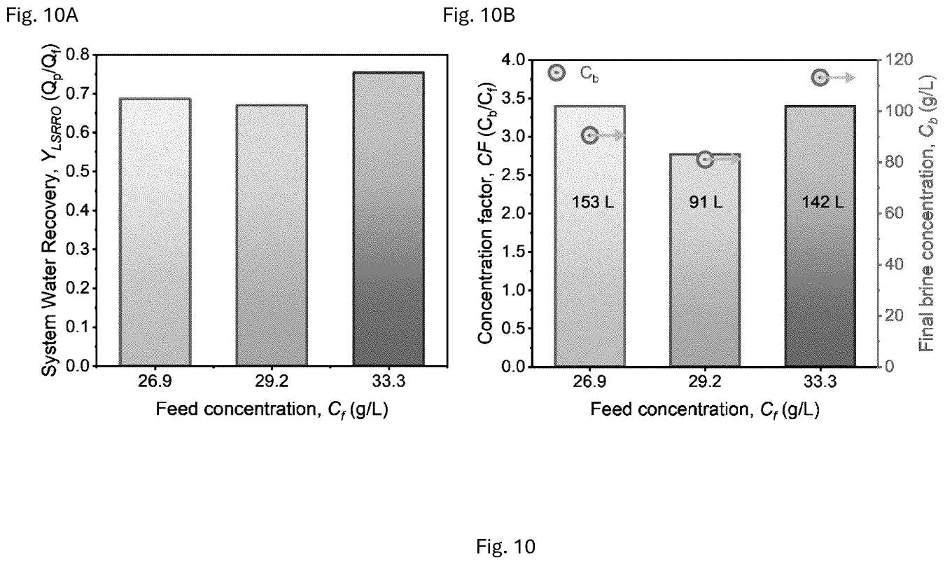

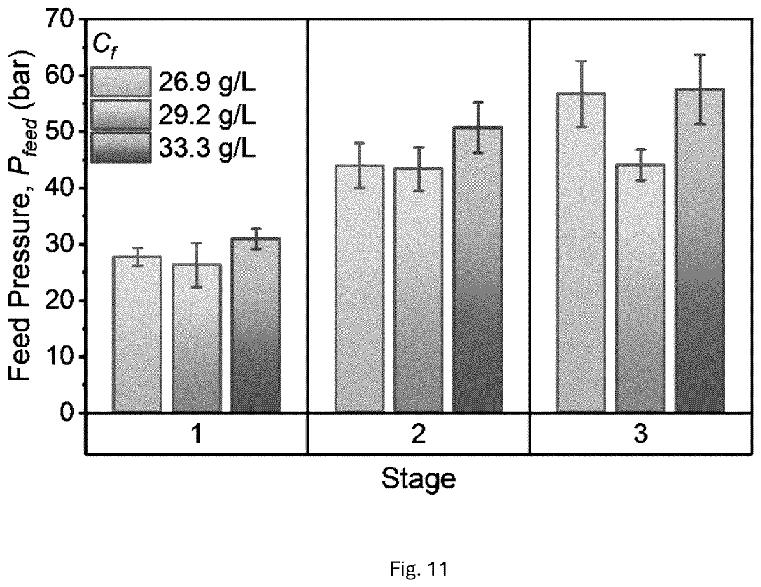

The LSRRO pilot stabilized after treating ˜50 L of feed, corresponding to the volume required for intermediate tanks to reach steady state (FIG. 9). Volumetric recoveries of 65% and higher (FIG. 10) were consistently obtained, and based on chloride concentrations, concentration factors were greater than three times the feed concentration. Final brine concentration exceeded 10% NaCl (114 g/L) when testing a 33.3 g/L feed (FIG. 11).

At the same time, inlet pressures to each module were considerably below 70 bar and increased monotonically with each stage (FIG. 9). This monotonic increase is expected as the average concentration in each element approached the stage exit concentration (C_{r,i}) due to the high recycling ratio within each stage (Q_{rec,i}) (Table 5). Hence, owing to the progressively greater average feed concentration as the stage number increased, feed pressure was also expected to rise. Actual performance of the system tracks the nominal characteristics of the modules with respect to rejection fairly well. In addition, the high recycle ratio results in average concentration on the high pressure side of the membrane for each stage (Cf_{ave,i}) being close to the exit concentration from each stage (C_{r,i}).

TABLE 5
Stage performance of LSRRO as function of initial
NaCl feed concentration

| Cf (g/L) | Stage | Q_{rec, i} (L/h) | C_{r, i} (g/L) | Cf_{ave, i} (g/L) | Rₙₒₘ |
|---|---|---|---|---|---|
| 26.9 | 1 | 201 | 0.36 | 0.33 | 99.5% |
| | 2 | 294 | 0.75 | 0.66 | 87.0% |
| | 3 | 210 | 1.59 | 1.38 | 68.6% |
| 29.2 | 1 | 194 | 0.34 | 0.31 | 99.4% |
| | 2 | 271 | 0.73 | 0.64 | 88.3% |
| | 3 | 240 | 1.40 | 1.26 | 60.9% |
| 33.3 | 1 | 198 | 0.43 | 0.41 | 99.5% |
| | 2 | 283 | 1.12 | 1.04 | 88.4% |
| | 3 | 205 | 1.95 | 1.85 | 64.4% |

The simplicity of the LSRRO with recycle system presented herein can be evidenced when comparing this scheme to the modified batch system reported in Van Houghton, et al. (ACS EST Water. 2024 Nov. 8; 4 (11): 5089-104) for the same case of NaCl synthetic brine (Table 6). The van Houghton study used an NaCl feed that was twice as concentrated (70 g/L vs 33.3 g/L), therefore justifying the need for higher pressures than those employed in this work. Accordingly, owing to the more dilute feed, lower brine concentrations were obtained in the LSRRO with recycle scheme. However, the LSRRO with recycle performance was superior, as both water recovery and concentration factor were higher (Table 6). Most importantly, the LSRRO with recycle employed one third the number of elements to process the brine at the same rate.

TABLE 6
Comparison of modified batch configuration implemented
in van Houghton et al. and LSRRO with recycle (this study),
with respect to performance and system complexity.

| System and | Modified batch | LSRRO with recycle |
|---|---|---|
| performance metrics | Van Houghon et al. | This study |
| No. of elements | 10 | 3 |
| Process tanks | 6 | 3 |
| Pumps | 3 | 3 |
| Feed flow, Q_{f} (L/h) | 45 | 47 |
| Recovery (%) | 68 | 75 |
| Maximum pressure (bar) | 74 | 59 |
| Max. feed concentration, | 70 | 33.3 |
| C_{f} (g/L) | | |
| Brine concentration, | 220^{a} | 114 |
| C_{b} (g/L) | | |
| Concentration Factor | 3.1 | 3.4 |
| (CF) | | |

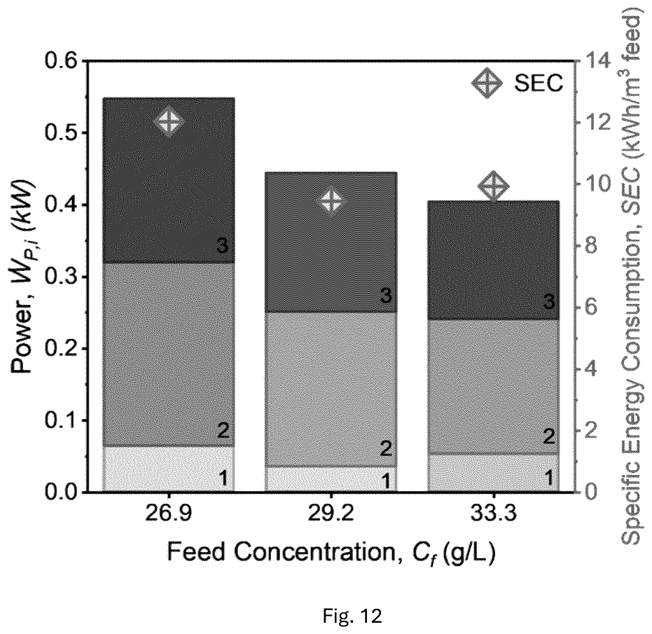

In terms of SEC, the LSRRO system reached a level ranging 10-12 kWh/m³ of feed brine. FIG. 12 shows the greatest portion of the SEC is consumed in the second and third stages. The higher permeate rate of the second stage (60-65 L/h for stage 2 vs. 40 L/h for stage 3) explains why the power consumed in each of these stages is comparable. This is substantially higher than projected for LSRRO without recycle and no interstage booster pumps. This trend is reasonable since each stage operates at nearly the brine exit concentration and the recycling entails loss of energy due to mixing. At the same time, the energy consumption is substantially less than thermal processes such as brine concentrators (18.5 kWh/m³) (AWWA 3010)(10). By optimizing the rejection properties of the modules and employing higher efficiency feed pumps, lowering energy requirements should be feasible. In a larger system with multiple elements in series in each stage and a higher recovery per pass, SEC should be further reduced.

With nearly 300 BWRO plants in the U.S. alone in 2018, brine management in small and medium sized desalination plants should now be achievable with this relatively simple design of pressure driven separation using flexible LSRRO recycle stages. They can handle variations in feed water salinity and changes in recovery of the primary BWRO unit, and the reduced brine volume will decrease costs of final ZLD steps, such as brine crystallizers. To realize this potential, future work will focus on optimizing rejection properties of the LSRRO stages after the SWRO first stage, to achieve brines reaching 15-20% TDS. (Bond, R. and Veerapaneni, V., Zero Liquid Discharge for Inland Desalination, AWWA Report 3010, 2007; Mickley M. Updated and Extended Survey of U.S. Municipal Desalination Plants. U.S. Department of Interior, Bureau of Reclamation, Technical Service Center; Denver, CO, USA: 2018. Desalination and Water Purification Research and Development Program Report No. 27)

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A reverse osmosis system, comprising:
a feed source input;
a high-pressure feed pump fluidly connected to the feed source input;
a first energy recovery device fluidly connected to the high-pressure feed pump;
a reverse osmosis (RO) cascade fluidly connected to the energy recovery device, wherein the RO cascade comprises:
a seawater reverse osmosis (SWRO) stage comprising a SWRO membrane, fluidly connected to the first energy recovery device; and
at least one low salt rejection reverse osmosis (LSRRO) stage comprising a LSRRO membrane, fluidly connected to the SWRO stage.

2. The system of claim 1, wherein the high-pressure feed pump is configured to:
i) receive and increase the pressure of a feed from the feed source input;
ii) receive and increase the pressure of a permeate output from the LSRRO stage; and
iii) receive and increase the pressure of a concentrate output from the SWRO stage.

3. The system of claim 2, wherein the first energy recovery device is configured to:
i) receive and increase the pressure of a recycle stream from the high-pressure feed pump; and
ii) recirculate the concentrate output from the SWRO stage to the high-pressure feed pump while recovering its mechanical energy.

4. The system of claim 1, wherein the LSRRO stage further comprises a second high pressure feed pump fluidly connected to the SWRO stage;
wherein the second high pressure feed pump is configured to:
i) receive and increase the pressure of a portion of a concentrate output by the SWRO stage;
ii) receive and increase the pressure of a portion of a permeate output by a second LSRRO or SWRO stage; and
iii) receive and increase the pressure of a portion of the concentrate output from the LSRRO stage.

5. The system of claim 4, wherein the LSRRO stage further comprises a second energy recovery device fluidly connected to the second high pressure feed pump;
wherein the second energy recovery device is configured to:
i) increase the pressure of a stream output from the second high pressure feed pump; and
ii) recirculate the portion of concentrate output by the LSRRO stage to the second high pressure feed pump while recovering its mechanical energy.

6. The system of claim 5, wherein the first and second energy recovery device is a pressure exchanger or pressure intensifier.

7. The system of claim 1, wherein the LSRRO stage further comprises a booster pump configured to boost the pressure of at least a portion of a permeate output by the LSRRO stage to an inlet of a downstream LSRRO stage or to the SWRO stage.

8. The system of claim 1, further comprising a monovalent selective electrodialysis (MSED) stage fluidly connected between the feed source and the RO cascade.

9. The system of claim 8, wherein the MSED stage comprises an electrodialysis stack of alternating monovalent selective cation exchange membranes (CEM) and monovalent selective anion exchange membranes (AEM).

10. The system of claim 9, wherein an input of the MSED stage includes an input configured to receive raw groundwater of low ion content water.

11. The system of claim 9, further comprising a scaling ion scavenging stage fluidly connected between the MSED stage and the RO cascade.

12. The system of claim 1, wherein the RO cascade further comprises an antiscalant input fluidly connected to an inlet of the at least one LSRRO stage.

13. The system of claim 12, wherein the antiscalant comprises a low molecular weight antiscalant.

14. The system of claim 1, wherein the LSRRO stage is downstream from the SWRO stage.

15. The system of claim 14, wherein the LSRRO stage comprises a second LSRRO or SWRO stage downstream from the LSRRO stage.

16. The system of claim 1, further comprising at least a second feed source fluidly connected to an outlet of the SWRO stage and an inlet of the LSRRO stage and configured to:
i) receive a concentrate output from the SWRO stage;
ii) optionally receive a permeate output from second a LSRRO stage or SWRO stage; and
iii) introduce a second feed to the LSRRO stage.

17. The system of claim 1, wherein the feed source is configured to receive a permeate output from at least one LSRRO stage and a concentrate output from the SWRRO stage.

18. A reverse osmosis method, comprising:
providing the reverse osmosis system of claim 1;
inputting a high salinity fluid into the feed source;
increasing the pressure of the high salinity fluid via the high-pressure feed pump to create an intermediate stream;
increasing the pressure of the intermediate stream via the energy recovery device to create a pressurized stream;
performing reverse osmosis on the pressurized stream via the SWRO stage to create a concentrate and a permeate; and
collecting the permeate.

19. The method of claim 18, further comprising recirculating the concentrate via the energy recovery device to the high-pressure feed pump while recovering its mechanical energy.

20. The method of claim 19, further comprising introducing the concentrate to the LSRRO stage.
